(19) United States
(12) Patent Application Publication
(10) Pub. No.: US 2007/0165534 A1
(43) Pub. Date: Jul. 19, 2007

(54) Method of indicating a signal characteristic

(75) Inventor: Krishna Prasad Panje, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,578

(22) PCT Filed: Feb. 28, 2005
(86) PCT No.: PCT/IB05/50725

§ 371 Date: Sep. 5, 2006

(30) Foreign Application Priority Data
Mar. 10, 2004 (EP) 04100974.7

(51) Int. Cl. H04J 1/16; H04B 7/005

(52) U.S. Cl. 370/252; 370/278

(57) ABSTRACT

There is described a method of indicating a signal characteristic in a communication system comprising a first communication apparatus (10) coupled in wireless communication with a second communication apparatus (80). The method is distinguished in that it includes steps of: (a) receiving one or more wireless transmissions (60) at the second apparatus (80); (b) analysing the one or more wireless transmissions (60) as received at the second apparatus (80) to determine at least one characteristic of the one or more wireless transmissions (60); (c) generating at least one return signal including information describing the at least one characteristic and communicating said at least one return signal from the second apparatus (80) to the first apparatus (10), and (d) receiving the at least one return signal at the first apparatus (10) and presenting said at least one characteristic to at least one user (90) of the first apparatus (10).

### FIELD OF THE INVENTION

The present invention relates to methods of indicating a signal characteristic; in particular, but not exclusively, the invention concerns a method of indicating signal strength in portable electronic apparatus, for example in mobile telephone handsets. Moreover, the invention also relates to apparatus operable to implement the method.

### BACKGROUND OF THE INVENTION

Contemporary portable electronic apparatus are becoming increasingly complex such that use of such items requires increasing degrees of user ability to appreciate information presented to them, often on miniature screens or displays. Such considerations especially pertain to mobile telephones which increasingly provide other facilities, for example graphic facilities such as SMS and calendar notepads, in addition to basic telephone speech communication. Elderly people with poorer eyesight and without technical training often experience difficulty with using such complex apparatus.

Complex apparatus also potentially operate in a sophisticated manner with numerous interactions occurring with other system components, for example a mobile telephone interacting with a repeater base-station. When a failure occurs in such interaction, it can often be difficult for a user of the apparatus to understand or appreciate a cause of such failure. Moreover, presentation of error codes and such like on a miniature screen is often meaningless to inexperienced users. In the case of mobile telephones, the inventor has appreciated that radiowave reception problems are a frequent cause of apparent malfunction of mobile telephone apparatus.

In a United Kingdom patent application no. GB 2,355,894, there is described a foldable portable telephone. When the telephone is in a folded state, a LED is used to enable a user of the telephone to determine whether or not the telephone is in range and can be used. The LED is arranged to be visible to the user when the telephone is unfolded. In operation, a receiving station receives a signal transmitted from a base station and a control unit controls the lighting of the LED according to the received signal. Preferably, the LED is lit in a first lighting pattern, for example continuously off, when the strength or signal-to-noise ratio (SNR) of the received signal is greater than or equal to a predetermined value, indicating inner zone status and lit in a second lighting pattern, for example continuously on, when the strength or SNR is below the predetermined value, indicating outer zone status. A third lighting pattern may be used when the receiving section receives an incoming call from the base station. The first and second lighting patterns may be reversed and there may be a liquid crystal display arranged to be visible only when the telephone is unfolded.

The inventor has appreciated that use of a LED as described in the foregoing potentially renders the portable telephone more complex and bulky than necessary. Moreover, interpretation of the significance of a flashing LED to some users will be potentially difficult and confusing. The inventor has envisaged that such reception status presentation is problematic and has therefore devised the present invention which at least partially addresses the problem.

In known portable electronic apparatus, for example mobile telephones, when coupled by wireless to remote receivers, users of the apparatus when making telephone calls are not provided with an indication of the receivers' situation, namely operating conditions. Such a lack of indication potentially may lead to frustration of the users because of repeated questions/queries from the remote receivers. The inventor has thus envisaged that it is advantageous to know whether or not the receivers are able to receive transmissions from the apparatus properly. By receiving indication of reception at the remote receivers, the users can take necessary steps to enhance signal quality at the receivers' side. These steps can include either by roaming around to improve signal reception strength, for example by utilizing radiation focusing characteristics of neighboring metallic objects, or by calling at a different time. Futhermore, user frustration is reduced because the users are aware of the receivers' inability to receive communications properly.

### SUMMARY OF THE INVENTION

An object of the invention is to provide more readily and easily interpretable feedback regarding a technical operating state of an apparatus.

According to a first aspect of the present invention, there is provided a method of indicating a signal characteristic in a communication system comprising a first communication apparatus coupled in wireless communication with a second communication apparatus, characterized in that the method includes the steps of:
(a) receiving one or more wireless transmissions at the second apparatus;
(b) analysing the one or more wireless transmissions as received at the second apparatus to determine at least one characteristic of the one or more wireless transmissions;
(c) generating at least one return signal including information describing the at least one characteristic and communicating said at least one return signal from the second apparatus to the first apparatus, and
(d) receiving the at least one return signal at the first apparatus and presenting said at least one characteristic to at least one user of the first apparatus (10).

The invention is of advantage in that the first apparatus is capable of providing more readily and easily interpretable feedback regarding a technical operating state of the second apparatus.

Preferably, the information conveyed in the at least one return signal is indicative of strength of magnetic radiation received at the second apparatus.

Preferably, in the method, presentation of said at least one characteristic conveyed in the at least one return signal is implemented by modifying a background colour and/or light emission flux of displaying means included in the first apparatus. More preferably, the background colour is represented in a majority of pixels included in the displaying means. The inventor has appreciated that it is better to utilize substantially most of an expanse of a display which users are accustomed to viewing to present an indication of technical operating conditions of the second apparatus in contradistinction to using subsidiary minute indicators, for example miniature LEDs, which are often non-intuitive to appreciate and difficult for poor-sighted people to see.

Preferably, in the method, presentation of the at least one characteristic is supplemented by a corresponding audio indication. Such audio indication is capable of reinforcing an impression of working status of the second apparatus presented to the one or more users of the first apparatus.

Preferably, in the method, the at least one return signal is communicated from the second apparatus to the first apparatus in a repetitive or substantially continuous manner. Such repetitive or substantially continuous manner of communication enables users of the first and/or second apparatus to iteratively change spatial position in order to improve transmission reception.

Preferably, in the method, the at least one return signal conveys the at least one characteristic by way of at least one of: one or more pulses, one or more tone bursts, phase modulation and digital data streams. More preferably, the one or more tone bursts have an associated tone frequency in a range corresponding substantially to that required for voice communication. Implementation of the one or more return signals by way of tone bursts is capable of rendering the method implementable within existing apparatus configured to communicate voice messages.

Preferably, in the method, the at least one return signal is conveyed from the second apparatus to the first apparatus by way of communication infrastructure. Use of such infrastructure renders the method applicable to contemporary mobile telephone systems including base stations as part of the aforesaid infrastructure.

According to a second aspect of the present invention, there is provided a method of indicating a signal characteristic in a communication apparatus, characterized in that the method includes the steps of:
(a) receiving one or more wireless transmissions at the apparatus;
(b) analysing the one or more wireless transmissions as received at the apparatus to determine at least one characteristic of the one or more wireless transmissions; and
(c) presenting said at least one characteristic to at least one user of the apparatus, said at least one characteristic being presented by modifying a background colour and/or light emission flux of displaying means included in the apparatus.

Preferably, in the method, the at least one characteristic concerns a radiation strength of the one or more transmissions as received at the apparatus.

Preferably, in the method, the at least one characteristic concerns amplitude or frequency spectrum characteristics of a signal conveyed by the one or more transmissions as received at the apparatus, said signal preferably being voice speech and/or music.

According to a third aspect of the present invention, there is provided a method of indicating a signal characteristic on a first communication apparatus, characterized in that the method includes the steps of:
(a) receiving a signal including information describing at least one characteristic of one or more wireless transmissions between a second communication apparatus (80) and a base station of a wireless communication system; and
(b) presenting said at least one characteristic to at least one user (90) of the first apparatus (10).

According to a fourth aspect of the present invention, there is provided a method of enabling indication of a signal characteristic on a first communication apparatus, characterized in that the method includes the steps of:
(a) analysing one or more wireless transmissions (60) between a second communication apparatus (80) and a base station of a wireless communication system to determine at least one characteristic of the one or more wireless transmissions; and
(b) generating at least one signal including information describing the at least one characteristic and communicating said at least signal to the first apparatus (10).

According to a fifth aspect of the invention, there is provided apparatus operable according to a method of the second aspect of the invention, the third aspect of the invention or the fourth aspect of the invention.

According to a sixth aspect of the present invention, there is provided software executable on one or more computing devices for implementing the method according to the second aspect of the invention, the third aspect of the invention or the fourth aspect of the invention.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

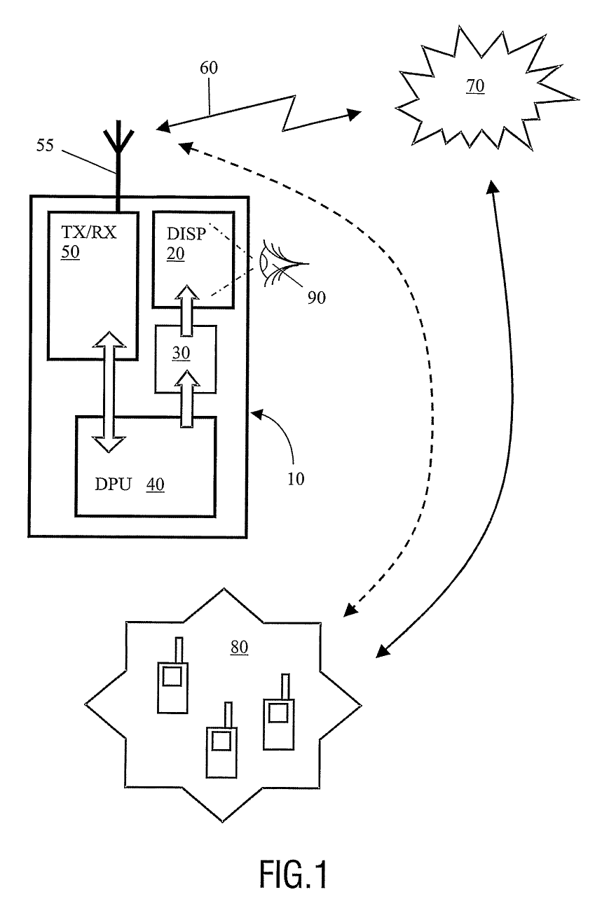

FIG. 1 is a diagram of an apparatus, namely a portable telephone, in wireless communication with remote apparatus, optionally via associated infrastructure; and

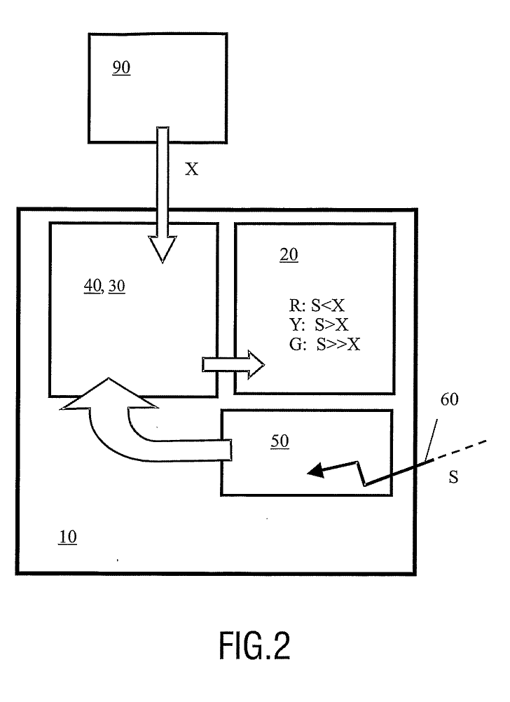

FIG. 2 is a diagram illustrating a configuration of the apparatus in FIG. 1 to present display background colours in response to characteristics of transmissions received at the apparatus.

### DESCRIPTION OF EMBODIMENTS OF THE INVENTION

In overview, the present invention is concerned with a portable electronic apparatus, for example a telephone as presented in FIG. 1 and indicated generally by 10. Preferably, the telephone 10 is a mobile telephone or cordless telephone. The telephone 10 includes a colour pixel display (DISP) 20. Preferably, the display 20 is implemented using one or more colour thin-film-transistor (TFT) pixel liquid crystal display (LCD) devices. Alternatively, or additionally, the display 20 is implemented using one or more electronic ink displays; preferably, the one or more displays employ electrically modifiable ink, namely “e-ink”, as described in a published European patent application no. EP 1,345,116 and as developed by Philips N.V. Beneficially, the display 20 is capable of displaying sixty four thousand different colours, namely providing 16-bit colour resolution.

The apparatus 10 further comprises a data processing unit (DPU) 40 connected via a display driving device 30 to the display 20, the processing unit 40 being operable to drive the device 30 for displaying visual information on the display 20. Moreover, the processing unit 40 is also coupled to a radio transceiver (TX/RX) 50 including a stub or patch antenna 55 to enable the telephone 10 to emit and/or receive information-bearing electromagnetic radio radiation 60, namely wireless radiowaves. By appropriately controlling the driving device 30, the processing unit 40 is operable to change a background colour presented on the display 20 in a manner as will be elucidated in more detail later. Moreover, the driving device 30 us also operable to present other information on the display 20 in a manner of contemporary mobile telephones, for example telephone numbers and SMS messages, to a user 90 of the telephone 10.

In operation, the telephone 10 is capable of being configured to communicate with other similar remote apparatus 80, for example via communication infrastructure 70 including one or more base stations. Moreover, the telephone 10 is also capable of communicating solely with the infrastructure 70. In particular, the processing unit 40 is arranged to modify the aforementioned background colour of the display 20 and/or the brightness of the background colour, such modification being dependent upon one or more of the following:
(a) the strength of the electromagnetic radio radiation 60 received at the telephone 10, namely the power of the radiation 60 or, alternatively, the magnitude of an electric or magnetic vector of the radiation 60 received at the telephone 10;
(b) characteristics of an information signal conveyed by the radiation 60 to the telephone 10; and
(c) characteristics of a voice signal conveyed by the radiation 60 to the telephone 10.

Moreover, the processing unit 40 is also alternatively or additionally capable of providing a supplementary information-indicative audio output, for example in a manner of one or more beeps or bleeps.

The telephone 10 is capable of being operated in conjunction with the infrastructure 70 and/or with the remote apparatus 80 in one or more of: first, second and third modes which will be elucidated in more detail later. Changing the background colour of the display 20 and/or generating one or more audio bleeps or beeps enables the user 90 quickly by glancing at the display 20 of the telephone 10 to have an appreciation of operation of one or more of: the apparatus 10, the infrastructure 70 and the remote apparatus 80. Preferably, one or more of the remote apparatus 80 are similar in design to the telephone 10.

Operation of the telephone 10 will now be described with reference to FIG. 1 for the first, second and third modes.

In the first mode of operation, a wireless transmission occurs from the infrastructure 70, for example a base station thereof, which is received as the radiation 60 at the telephone 10. The user 90 of the telephone 10 can elect, for example by suitably configuring the processing unit 40 of the telephone 10, so that the strength of the transmission received as the radiation 60 at the telephone 10 is analyzed in the processing unit 40 for varying the background light colour and/or light emission flux from the display 20 in response to the received signal strength. The transmission is optionally also received at the remote apparatus 80. The user 90 is thereby capable, by merely glancing at the display 20, of receiving an impression of quality of communication connection between the telephone 10 and the infrastructure 70. Preferably, the transmission from the infrastructure 70 to the telephone 10 occurs repetitively or continuously so that the background colour and/or light emission flux from the display 20 is updated dynamically in a substantially continuous manner.

By glancing at the display 20 whilst moving spatially between a number of test positions, the user 90 is thereby capable of determining a location in his/her environment where the radiation 60 received at the telephone 10 is maximized, for example by virtue of beneficial reflection of the radiation 60 from metallic objects in proximity to the telephone 10. For example, the user 90 is potentially capable of improving reception of the signal conveyed by the radiation 60 by, for example, roaming around a room or rotating to change orientation. Thus, in the first mode, the user 90 is capable of optimizing communication between the telephone 10 and the infrastructure 70. When a maximum signal strength is found at a given location, the user 90 can then remain at the given location, for example for a remainder of a telephone call.

In the second mode of operation, there is the telephone 10 and the remote apparatus 80. A transmission occurs from the remote apparatus 80 to the telephone 10, the transmission being received at the telephone 10 as the radiation 60. The user 90 can elect, for example by suitably configuring the telephone 10, so that a communication conveyed from the remote apparatus 80 by the transmission received as the radiation 60 at the telephone 10 is passed as a signal from the transceiver 50 to the processing unit 40. The signal is analyzed in the processing unit 40 which is operable, in response to some characteristic of the signal, to vary the background colour of the display 20 and/or light emission flux from the display 20. Preferably, the aforesaid characteristic can be amplitude of an audio signal modulated onto the transmission, namely the radiation 60, or relative frequency distribution of energy in the audio signal; for example, the display 20 presents a yellow background colour when the audio signal has predominantly higher frequency tones, whereas the display 20 presents a red background colour when the audio signal has predominantly lower frequency tones. Preferably, in the second mode, the display 20 is repetitively or substantially continuously updated. The second mode of operation is of advantage in that it is capable of presenting trendy visual effects to the user 90, for example as potentially popular amongst teenagers and children using the telephone 10 when communicating with one another. However, the second modes can also be of considerable benefit to persons who have hearing difficulties, for example with regard to interpreting audio speech and/or when initially inputting a telephone number and interpreting various audio ring tones before a telephone connection is established, said ring tones often being of subdued amplitude, namely faint, and therefore difficult for a partially deaf individual to interpret.

In the third mode of operation, the telephone 10 and the remote apparatus 80 are both involved. A transmission as electromagnetic radio radiation occurs from the infrastructure 70 to the remote apparatus 80; the transmission corresponds, for example, to a telephone call from the telephone 10 to the infrastructure 70 which is relayed therethrough to the remote apparatus 80. Next, the apparatus 80 performs an analysis of the transmission as received at the remote apparatus 80 to determine its received signal strength and subsequently generates a return signal which the remote apparatus 80 communicates to the telephone 10, thereby providing the telephone 10 with information regarding transmission reception conditions at the remote apparatus 80, the remote apparatus 80 optionally communicating to the telephone 10 via the infrastructure 70. On receipt of the return signal, the telephone 10 provides an indication of the received signal strength as determined at the remote apparatus 80 to the user 90. Preferably, the indication of the received signal strength is presented to the user 90 by way of modifying one or more of: background colour and brightness of the display 20; for example, a weak reception of electromagnetic radiation at the remote apparatus 80 causes the display 20 of the telephone 10 to present a red background colour to the user 90, whereas a strong reception at the remote apparatus 80 causes the display 20 of the telephone 10 to present a green background colour to the user 90. Preferably, the telephone 10 is repetitively or substantially continuously updated with return signals indicative of strength of reception at the remote apparatus 80, thereby enabling the telephone 10 to provide the user 90 with a dynamically updated indication of reception conditions at the remote apparatus 80. Such an indication enables the user 90 to appreciate operating conditions at the remote apparatus 80 and thereby potentially circumvents frustration and confusion when making a telephone call.

For example, as illustrated in FIG. 2, the user 90 enters a parameter X into the processing unit 40 to define a threshold level for purposes of information presentation on the display 20 to the user 90. When the aforementioned one or more return signals conveying information S regarding received transmission strength at the remote apparatus 80 is less than the parameter X, the display 20 presents a red (R) background colour on the display 20 to the user 90. Alternatively, when the aforementioned one or more return signals conveying information S regarding received transmission strength at the remote apparatus 80 is substantially equal to the parameter X, the display 20 presents a yellow (Y) background colour on the display 20 to the user 90. As a further alternative, when the aforementioned one or more return signals conveying information S regarding received transmission strength at the remote apparatus 80 is more than the parameter X, the display 20 presents a green (G) background colour on the display 20 to the user 90.

The aforementioned return signal is preferably implemented as one or more pulses or tone bursts conveyed as modulation on a return wireless transmission; alternatively, or additionally, phase modulation and/or inclusion of a digital data stream can be employed to convey the return signal. Preferably, the return wireless transmission is conveyed either directly from the remote apparatus 80 to the telephone 10, or via the infrastructure 70.

It will be appreciated, for example in a communication system as depicted in FIG. 1 comprising the telephone 10, the infrastructure 70 and the remote apparatus 80 that more than one of the aforementioned first, second and third modes of operation can be executed concurrently. For example, where the remote apparatus 80 is similar to the telephone 10, the remote apparatus 80 can be operable to employ the first mode of operation concurrently with the remote apparatus 80 and the telephone 10 in co-operation implementing the third mode of operation. As a further example, the remote apparatus 80 can be configured to employ the second mode of operation concurrently with the remote apparatus 80 in co-operation with telephone 10 implementing the third mode of operation. As a yet further example, the remote apparatus 80 and the telephone 10 can be configured to concurrently implement the third mode of operation so that the telephone 10 is capable of monitoring transmission reception conditions at the remote apparatus 80 simultaneously with the remote apparatus 80 monitoring transmission reception conditions at the telephone 10. As elucidated in the foregoing, the remote apparatus 80 preferably corresponds to one or more telephones similar to the telephone 10. As a further example, especially in the case of teenagers desirous of trendy visual display presentations or partially deaf users wishing to have mutual assistance with interpreting aurally conveyed information, both the telephone 10 and the remote apparatus 80 can be configured to both implement the second mode of operation.

The aforementioned tone burst in the third mode of operation is preferably substantially in a voice frequency range, namely in a frequency range of 100 Hz to 2 kHz. More preferably, the tone burst is substantially in a range of 200 Hz to 1 kHz, and most preferably substantially 500 Hz. The tone burst is optionally a single burst, although it can be repetitive. More preferably, each one or more tone bursts is limited to a duration not exceeding 1 second.

Modes of operation of the telephone 10, and similarly the remote apparatus 80, can be configured by their respective users, for example the user 90 entering parameters, for example via a keyboard (not shown) of the telephone 10, into the processing unit 40. With regard to the second mode of operation, the user 90 and/or the infrastructure 70, for example invoked by the user 90, is capable of arranging for the telephone 10 to map to its display 20, for example, violet colour to voice signal energy conveyed in the radiation 60 in a range of 800 Hz to 850 Hz, red colour to voice signal energy in a range of 850 Hz to 950 Hz, and so on. Moreover, the mapping is alternatively, or additionally, arranged to map relative amplitude at different audio frequencies to different colours for presentation on the display 20, namely K=M_{f}(F,A) where K; M_{f}, F and A correspond to colour, a user-inputted mapping function, frequency and amplitude respectively. Such mapping is preferably implemented in a repetitive or pseudo-continuous manner.

Background colours presented on the display 20 can be preferably arranged to be aesthetically pleasing, for example “trendy”, as in smooth fading, moving or visually “melting” colour bars on a text area of the display 20.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of indicating a signal characteristic in a communication system comprising a first communication apparatus (10) coupled in wireless communication with a second communication apparatus (80), characterized in that the method includes the steps of:
(a) receiving one or more wireless transmissions (60) at the second apparatus (80);
(b) analysing the one or more wireless transmissions (60) as received at the second apparatus (80) to determine at least one characteristic of the one or more wireless transmissions;
(c) generating at least one return signal including information describing the at least one characteristic and communicating said at least one return signal from the second apparatus (80) to the first apparatus (10), and
(d) receiving the at least one return signal at the first apparatus (10) and presenting said at least one characteristic to at least one user (90) of the first apparatus (10).

2. A method of indicating a signal characteristic on a first communication apparatus, characterized in that the method includes the steps of:
(a) receiving a signal including information describing at least one characteristic of one or more wireless transmissions between a second communication apparatus (80) and a base station of a wireless communication system; and
(b) presenting said at least one characteristic to at least one user (90) of the first apparatus (10).

3. A method according to claim 2 wherein presentation of said at least one characteristic conveyed in the at least one return signal is implemented by modifying a background colour and/or light emission flux of displaying means (20) included in the first apparatus (20).

4. A method according to claim 3, wherein the background colour is represented in a majority of pixels included in the displaying means (20).

5. A method according to claim 2 wherein, in step (b), presentation of the at least one characteristic is supplemented by a corresponding audio indication.

6. A method according to claim 2, wherein the information received in the signal is indicative of strength of magnetic radiation received at the second apparatus.

7. A method according to claim 2, wherein the signal is received in a repetitive or substantially continuous manner.

8. A method according to claim 2, wherein the signal conveys the at least one characteristic by way of at least one of: one or more pulses, one or more tone bursts, phase modulation, digital data streams.

9. Apparatus (10) operable according to a method of claim 2.

10. Software executable on one or more computing devices for implementing the method of claim 2.

11. A method of enabling indication of a signal characteristic on a first communication apparatus, characterized in that the method includes the steps of:
(a) analysing one or more wireless transmissions (60) between a second communication apparatus (80) and a base station of a wireless communication system to determine at least one characteristic of the one or more wireless transmissions; and
(b) generating at least one signal including information describing the at least one characteristic and communicating said at least signal to the first apparatus (10).

12. A method according to claim 11, wherein the information conveyed in the at least one signal is indicative of strength of magnetic radiation received at the second apparatus.

13. A method according to claim 11, wherein the at least one signal is communicated to the first apparatus (10) in a repetitive or substantially continuous manner.

14. A method according to claim 11, wherein the at least one signal conveys the at least one characteristic by way of at least one of: one or more pulses, one or more tone bursts, phase modulation, digital data streams.

15. Apparatus (80) operable according to a method of claim 11.

16. Software executable on one or more computing devices for implementing the method of claim 11.
